(19) United States
(12) Patent Application Publication
(10) Pub. No.: US 2016/0188592 A1
(43) Pub. Date: Jun. 30, 2016

(54) TAG PREDICTION FOR IMAGES OR VIDEO CONTENT ITEMS

(71) Applicant: Facebook, Inc., Menlo Park, CA (US)

(72) Inventors: Robert D. Fergus, New York, NY (US); Lubomir Bourdev, Mountain View, CA (US); Emily Lynn Denton, New York, NY (US); Jason E. Weston, New York, NY (US)

(21) Appl. No.: 14/582,731

(22) Filed: Dec. 24, 2014

(51) Int. Cl. G06F 17/30; G06N 99/00; G06Q 50/00

(52) U.S. Cl. CPC G06F 17/30038; G06F 17/30035; G06F 17/3002; G06F 17/30867; G06F 17/30893; G06Q 50/01; G06N 99/005

(57) ABSTRACT

Systems, methods, and non-transitory computer-readable media can create, in a training phase, a first content item representation of a first content item based on a first content item transformation. The first content item can comprise one or more of images and video. A first user metadata representation of first user metadata may be created based on a first user metadata transformation. The first content item representation and the first user metadata representation can be combined to produce a first combined representation. The first combined representation and a first tag representation of a first tag can be embedded in an embedding space within a first threshold distance from one another.

### TECHNICAL FIELD

The technical field relates to the field of social networks. More particularly, the technical field relates to content classification techniques in social networks.

### BACKGROUND

Social networks provide interactive and content-rich online communities that connect members with one another. Members of social networks may indicate how they are related to one another. For instance, members of a social network may indicate that they are friends, family members, business associates, or followers of one another, or members can designate some other relationship to one another. Social networks often allow members to message each other or post messages to the online community.

Social networks may also allow members to share content with one another. For example, members may create or use pages with interactive feeds that can be viewed across a multitude of platforms. The pages may contain images, video, and other content that a member wishes to share with certain members of the social network or to publish to the social network in general. Members may also share content with the social network in other ways. In the case of images, members, for example, may publish the images to an image board or make the images available for searches by the online community. It is often difficult to predict the types of tags or other annotations users are likely to associate with content.

### SUMMARY

Various embodiments of the present disclosure include systems, methods, and non-transitory computer-readable configured to create, in a training phase, a first content item representation of a first content item based on a first content item transformation. The first content item can comprise one or more of images and video. A first user metadata representation of first user metadata may be created based on a first user metadata transformation. The first content item representation and the first user metadata representation can be combined to produce a first combined representation. The first combined representation and a first tag representation of a first tag can be embedded in an embedding space within a first threshold distance from one another.

In an embodiment, the user metadata includes one or more of: a gender, an age range, a country, a city, and Global Positioning System (GPS) coordinates of an individual who generated the first content item. The age range can comprise one of a set of discrete age brackets.

In an embodiment, combining the first content item representation and the first user metadata representation to produce the first combined representation comprises concatenating the first content item representation and the first user metadata representation.

In an embodiment, combining the first content item representation and the first user metadata representation to produce the first combined representation comprises multiplying the first content item representation and the first user metadata representation.

Creating the first content item representation of the first content item based on the first content item transformation can comprise: creating a content item vector corresponding to the first content item; and multiplying the content item vector by a content transformation matrix.

Further, in an embodiment, the creating the first user metadata item representation of the first user metadata based on the first user metadata transformation comprises: creating a user metadata item vector corresponding to the first user metadata; and multiplying the user metadata vector by a user metadata transformation matrix.

The systems, methods, and non-transitory computer-readable can comprise, in an evaluation, stage, creating a second content item representation of a second content item based on a second content item transformation. A second user metadata representation of second user metadata can be created based on a second user metadata transformation. The second content item representation and the second user metadata representation can be combined to produce a second combined representation. The second combined representation can be embedded in the embedding space. At least one tag associated with the second combined representation in the embedding space can be identified within a second threshold distance from the second combined representation.

In an embodiment, the first content item transformation and the second content item transformation are the same, and the first user metadata transformation and the second user metadata transformation are the same.

In an embodiment, the first content item comprises an image or video being uploaded to a social networking system.

Other features and embodiments are apparent from the accompanying drawings and from the following detailed description.

### BRIEF DESCRIPTION OF THE DRAWINGS

FIG. 1 shows an example diagram of a tag prediction system, in accordance with some embodiments.

FIG. 2 shows an example diagram of an embedding space training module, in accordance with some embodiments.

FIG. 3 shows an example diagram of a tag prediction execution module, in accordance with some embodiments.

FIG. 4 shows an example diagram of a process for training to embed content items and tags, in accordance with some embodiments.

FIG. 5 shows an example diagram of a process for training to embed content items and tags, in accordance with some embodiments.

FIG. 6 shows an example diagram of a process for predicting tags for a content item, in accordance with some embodiments.

FIG. 7 shows an example diagram of a process for predicting tags for a content item, in accordance with some embodiments.

FIG. 8 is a network diagram of an example social networking environment in which to implement the elements of the tag prediction system, in accordance with some embodiments

FIG. 9 shows an example diagram of a computer system that may be used to implement one or more of the embodiments described herein in accordance with some embodiments.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles described herein.

### DETAILED DESCRIPTION

### Tag Prediction for Images or Video Content Items

A social networking system may provide users with the ability to generate content and share it with friends. Users of a photo-sharing service of the social networking system may enjoy capturing images (e.g., still images, memes), video, or interactive content on their mobile phones and sharing the content with their online friends. Similarly, users may enjoy sharing content with their friends by, for example, updating interactive feeds on their homepage. A social networking system may also provide or support the ability to tag (e.g., indicate, identify, categorize, label, describe, or otherwise provide information about) an item of content or attributes about the content. One way to tag information is through a hashtag (e.g., a character sequence that begins with the hash symbol “#”) that identifies or otherwise relates to objects, subject, scenes, or other subject matter of the content or its attributes. Though it may be desirable to predict the types of tags a user is likely to associate with content, it is often difficult to do so. A system that predicts the types of tags a user is likely to associate with content may be helpful.

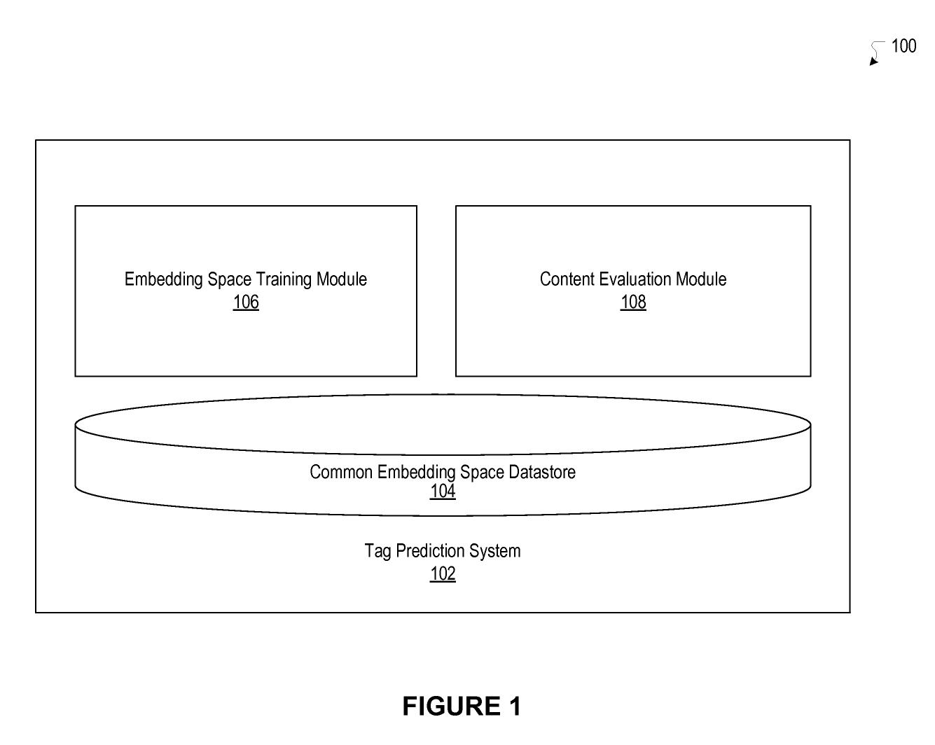

FIG. 1 shows an example diagram 100 of a tag prediction system 102, in accordance with some embodiments. The tag prediction system 102 includes a common embedding space datastore 104, an embedding space training module 106, and a content evaluation module 108. In the tag prediction system 102, the common embedding space datastore 104 may include a common embedding space in which combinations of content items and user metadata, and tags are represented.

The common embedding space datastore 104 comprises a datastore that stores a common embedding space that represents combinations of content items (e.g., images, memes, videos, interactive audiovisual material, etc.) and user metadata associated with the content items, and tags. In an embodiment, the common embedding space comprises combined values for content items and user metadata associated with those content items. For example, a value in the common embedding space may reflect information related to a combination of a specific content item as well as user metadata (e.g., gender, age and/or age ranges, country, city, Global Positioning System (GPS) coordinates, etc.) of a user associated with the specific content item. The common embedding space may include a linear space, and the values of the common embedding space may include vectors corresponding to points in the common embedding space.

In various embodiments, the distances between two or more values in the common embedding space can represent a measure of correspondence between those values. For example, the distance between two values representing content items in the common embedding space may represent how similar those content items are to one another. As another example, the distance between a representation of a tag and a representation of a content item (or a representation of a combination of a content item and associated user metadata) in the common embedding space may represent the extent the tag corresponds to the content item (or to the combination of the content item and the user metadata). In general, a degree of relationship between two vectors in the common embedding space may be reflected by the distance between the vectors.

The embedding space training module 106 may embed training content items, user metadata associated with training content items, and training tags in the common embedding space. The embedding space training module 106 may include training content items, with associated user metadata, and training tags that represent the types of items that will be evaluated by the content evaluation module 108, as discussed further herein.

During a training phase, the embedding space training module 106 may represent training content items as content item vectors, represent user metadata associated with the training content items as user metadata vectors, and represent tags as tag vectors. The embedding space training module 106 may use a content transformation matrix to transform the content item vectors into a format that can be directly embedded into the common embedding space, or can be combined with transformed user metadata, as discussed further herein.

In an embodiment, the embedding space training module 106 includes a user metadata transformation matrix to transform the user metadata vectors into a format that can be combined with content items. In an embodiment, the embedding space training module 106 combines transformations of content item vectors and user metadata vectors. The combinations can be embedded into the common embedding space.

The embedding space training module 106 may further use tag transformation matrices to transform tag vectors into a format that can be embedded in the common embedding space. The embedding space training module 106 may further embed transformations of tag vectors in the common embedding space.

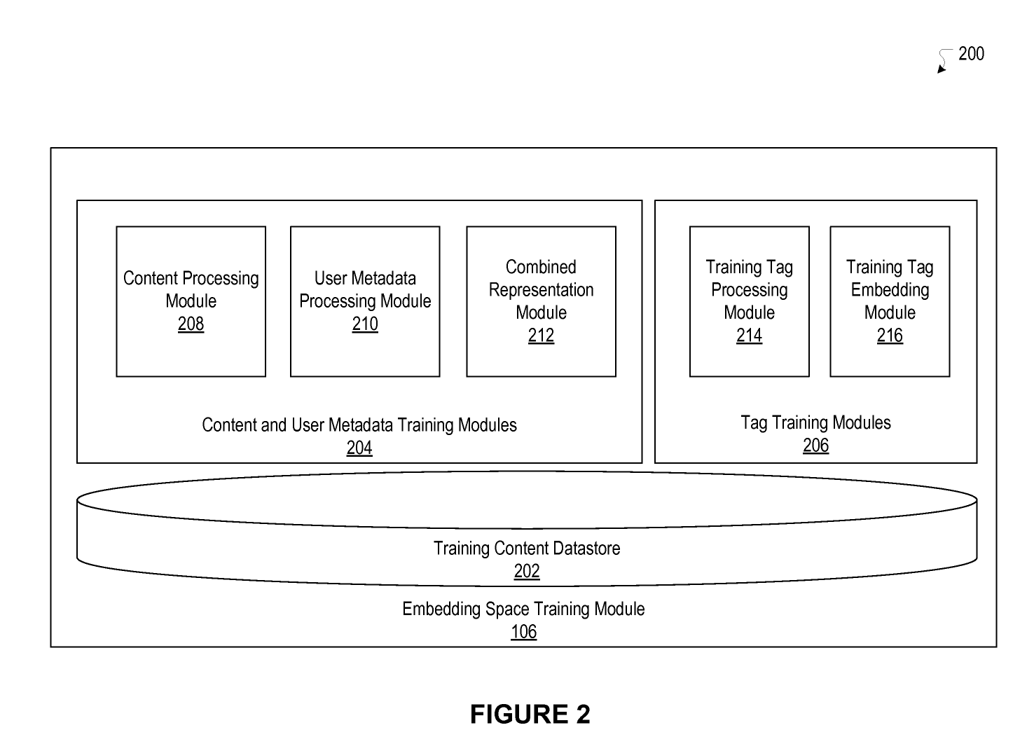

In various embodiments, the embedding space training module 106 trains the content transformation matrices using the training content items. More specifically, the embedding space training module 106 may train the content transformation matrices to transform the content item vectors to specific values that can be later used in an evaluation phase. The embedding space training module 106 may similarly train the metadata transformation matrices using the user metadata associated with the training content items, and train the tag transformation matrices to transform tag vectors using the tags associated with the training content items. FIG. 2 shows the embedding space training module 106 in greater detail.

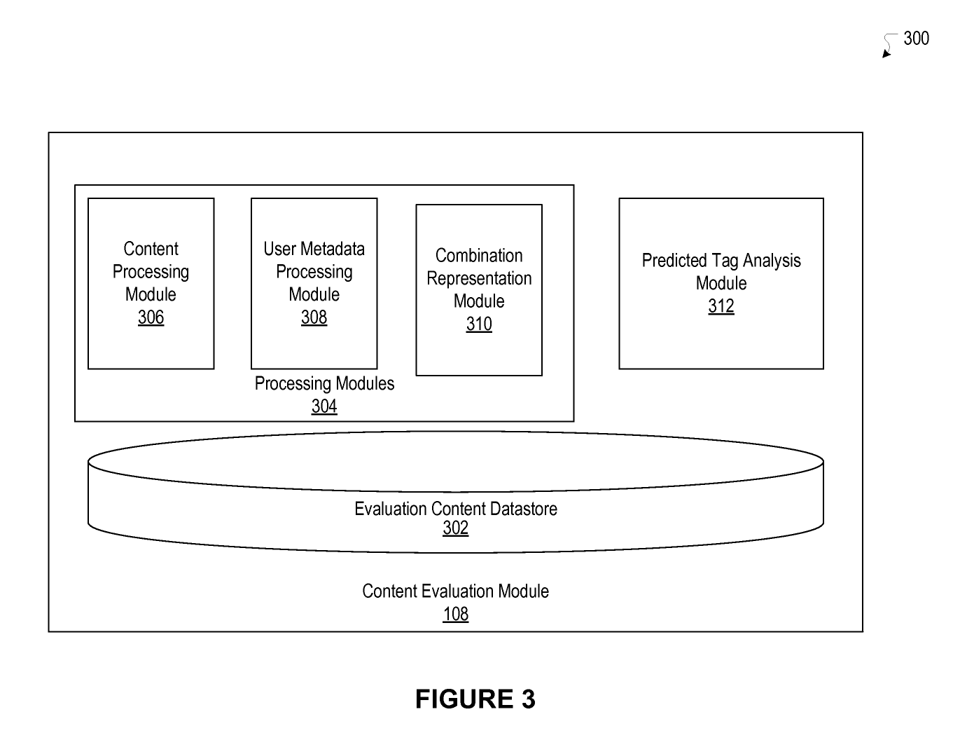

The content evaluation module 108 may predict the tags that are likely to be associated with combinations of specific content items and user metadata based on proximity in the common embedding space. In an embodiment, the content evaluation module 108 predicts the tags a user of a social networking system will likely use for a given combination of content and user metadata. As a result, the content evaluation module 108 may operate to predict the types of tags users of a social networking system will employ for various content items, as discussed further herein. FIG. 3 shows the content evaluation module 108 in greater detail.

FIG. 2 shows an example diagram 200 of an embedding space training module 106, in accordance with some embodiments. The embedding space training module 106 includes a training content datastore 202, content and user metadata training modules 204, and tag training modules 206. One or more of the modules of the embedding space training module 106 may be coupled to one another or to modules not explicitly shown in FIG. 2.

The training content datastore 202 may include a datastore configured to store training content. The training content may include images, memes, videos, interactive audiovisual material, and other content items that are useful for training the common embedding space. In an embodiment, the training content includes, for example, a variety of object classes, subject classes, and scene classes. As an example, the training content may include various images, including but not limited to images representative of dogs, cats, human faces, human figures, horses, beach scenes, city scenes, buildings, specific objects, etc. In an embodiment, the variety of classes of training content are representative of the types of content for which tags are to be predicted during the evaluation phase. For example, the variety of classes of training content may be chosen to be representative of the content typically uploaded by users of a social networking system.

In some embodiments, at least some of the items of training content in the training content datastore 202 are associated with user metadata. User metadata may include any information related to users who generate content items that may provide an indicator as to the objects within the content items. Examples of user metadata include demographic information related to a user, such as the gender of the user, the age of the user, etc. Examples of user metadata may also include information related to the location of a user, such as the country of the user, the city of the user, the Global Positioning System (GPS) coordinates of the user, etc. Examples of user metadata may further include information related to a user's activities on a social networking system, such as the types of content the user and/or friends of the user like on the social networking system, the types of content the user and/or the friends of the user post about on the social networking system, etc.

It is noted that in various embodiments, the items of training content need not be associated with user metadata. That is, in these embodiments, the content items in the training content datastore 202 may comprise images and/or video without having user metadata or other similar information associated therewith. As will be discussed further herein, items of training content not associated with user metadata may be represented as content item vectors, transformed using a content transformation matrix, and embedded without user metadata into the common embedding space.

In some embodiments, the content items in the training content datastore 202 are associated with training tags. The training tags may include tags (e.g., hashtags, etc.) for the content items. In some embodiments, the training tags include hashtags that correspond to, for example, object classes, subject classes, and scene classes represented by the content items. For example, the training tags may include tags that users are likely to associate with dogs, cats, human faces, human figures, horses, beach scenes, city scenes, buildings, specific objects, etc. In an embodiment, the training tags are representative of the tags used by users of a social networking system.

The content and user metadata training modules 204 may include a set of modules that combine training content and user metadata that is associated with the training content, and embed representations of combinations of the training content and the user metadata in the common embedding space. The content and user metadata training modules 204 include a content processing module 208, a user metadata processing module 210, and a combined representation module 212.

The content processing module 208 may process training content from the training content datastore 202. In some embodiments, the content processing module 208 represents training content as content item vectors that uniquely identify specific items of training content in a vector format. The content processing module 208 may use a content transformation matrix to transform the content item vectors into a format that can be combined with a representation of user metadata, as described further herein. The content transformation matrix may transform content item vectors in a manner that causes transformations of similar content items to be in proximity to one another in the common embedding space. For example, the content transformation matrix may cause transformations of similar content items to have values that are in proximity to one another. In some embodiments, the content processing module 208 multiplies content item vectors with the content transformation matrix to transform the content item vectors. The transformations implemented by the content transformation matrix (and other matrices described herein) may be linear, non-linear, or a combination of both. Specific values corresponding to the rows and/or columns of the content transformation matrix may be assigned and learned during the training phase.

In some embodiments, the content processing module 208 implements machine recognition techniques to identify visual attributes of specific content items. As an example, the content processing module 208 can use the information from a neural network, such as a convolutional neural network, to identify visual attributes of content items. The content processing module 208 may also perform other operations on content item vectors, such as reducing the number of dimensions of content item vectors by projecting those content item vectors into lower-dimensional subspaces. In an embodiment, the content processing module 208 may remove redundant information from the output of the convolutional neural network. Removing redundant information may include linearizing the output of the convolutional neural network, removing unnecessary dimensions from vectors associated with the output of the convolutional neural network, etc.

The content processing module 208 may provide representations of content items (e.g., the results of the content transformation matrix applied to content item vectors) to the other modules of the embedding space training module 106. In an embodiment, the content processing module 208 provides representations of content items to the combined representation module 212.

The user metadata processing module 210 may process user metadata associated with training content. The user metadata may correspond to training content gathered from the training content datastore 202. In an embodiment, the user metadata processing module 210 represents user metadata as user metadata vectors. For example, the user metadata processing module 210 may represent as user metadata vectors all of or some subset of users' ages, users' genders, users' countries, users' cities, and/or users' GPS coordinates into vector values. A vector assigned to user metadata may have, as its entries: a user's age and/or age range (e.g., 0-12; 13-18; 19-25; 25-35; above 35; etc.); the user's gender; the user's country; the user's city; the user's GPS coordinates; etc. The user metadata processing module 210 may provide the vector reflecting user metadata to other modules of the embedding space training module 106.

The user metadata processing module 210 may further use a user metadata transformation matrix to transform user metadata vectors into a format that can be combined with representations of content items. In some embodiments, the user metadata processing module 210 multiplies the user metadata transformation matrix with user metadata vectors to transform the user metadata vectors. In an embodiment, the user metadata processing module 210 provides representations of user metadata (e.g., the results of the user metadata transformation matrix applied to user metadata vectors) to the combined representation module 212. Specific values corresponding to the rows and/or columns of the user metadata transformation matrix may be assigned and learned during the training phase.

The combined representation module 212 may combine the representations of the content items and the representations of the user metadata and embed these combinations in the common embedding space. In an embodiment, the combined representation module 212 receives the representations of specific content items and the representations of user metadata for the specific content items from the content processing module 208.

The combined representation module 212 may combine the representations of the specific content items and the representations of the user metadata with one another to obtain a combined representation that can be embedded in the common embedding space. The combined representation may include a combination vector that reflects information related to the representations of the specific content items and information related to the representations of the user metadata.

The combined representation module 212 may create the combined representation in a variety of ways. In an embodiment, the combined representation module 212 can concatenate (i.e., add) values of the user metadata vectors to the values of the content item vectors to create combined vectors. A combined transformation matrix can be applied to the combined vector to produce a vector that can be embedded into an associated common embedding space. The combined transformation matrix can be an alternative to a separate content transformation matrix and a separate user metadata transformation matrix. The combined transformation matrix can have dimensions that accommodate the larger dimensions of the combined vectors.

In another embodiment, the combined representation module 212 can multiply the representations of the specific content items (e.g., result of the content transformation matrix applied to the content item vector) and the representations of the user metadata (e.g., result of the user metadata transformation matrix applied to the user metadata vector) with one another. More specifically, the combined representation module 212 can multiply corresponding elements of the vector associated with the representation of the content item and the vector associated with the representation of the user metadata to produce a combined vector that can be embedded in the common embedding space.

In some embodiments, the combined representation module 212 can create a tensor based on the representations of the specific content items and the representations of the user metadata. It is noted that combined representations may be created in any suitable way, including using the techniques described in Jason Weston et al., “WSABIE: Scaling up to Large Scale Vocabulary Image Annotation,” IJCAI′11 Proceedings of the Twenty-Second International Joint Conference on Artificial Intelligence—Vol. 3 at 2764-2770, which is hereby incorporated by reference herein in its entirety.

Though at least some of the foregoing examples have described the combined representation module 212 as combining representations of the content items and representations of the user metadata associated with the content items it is noted that in various embodiments, user metadata need not be used at all in embedding the content items. As a result, in various embodiments, the combined representation module 212 is optional. In these embodiments, the content processing module 208 may directly embed representations of content items in the common embedding space.

The tag training modules 206 may include a set of modules that represent training tags in the common embedding space. The tag training modules 206 include a training tag processing module 214 and a training tag embedding module 216.

The training tag processing module 214 may process training tags in the training content datastore 202. In an embodiment, training tag processing module 214 represents specific training tags as tag vectors. The training tag processing module 214 may also implement a tag transformation matrix that transforms tag vectors into a format that can be embedded in the common embedding space. The transformation of tag vector values may depend on the extent the specific training tags are close to representations of combinations of content items and user metadata. For example, training tags that are likely to correspond to an image of dogs, cats, human faces, human figures, horses, beach scenes, city scenes, buildings, specific objects, etc. may be transformed by the tag transformation matrix to have values that are close to the representations of combinations of content items and user metadata of content items containing dogs, cats, human faces, human figures, horses, beach scenes, city scenes, buildings, specific objects, etc. Specific values corresponding to the rows and/or columns of the tag transformation matrix may be assigned and learned during the training phase.

In various embodiments, the training tag embedding module 216 embeds the representations of tag vectors (e.g., results of the tag representation matrix applied to tag vectors) into the common embedding space.

In various embodiments, the tags associated with training content items may be identified using any suitable technique. Content items constituting or including images or text may be analyzed and classified based on any suitable processing technique. For example, an image classification technique may gather contextual cues for a sample set of images and use the contextual cues to generate a training set of images. The training set of images may be used to train a classifier to generate visual pattern templates of an image class. The classifier may score an evaluation set of images based on correlation with the visual pattern templates. The highest scoring images of the evaluation set of images may be deemed to be mostly closely related to the image class. One possible image classification technique is described in U.S. Nonprovisional application Ser. No. 13/959,446, filed on Aug. 5, 2013, which is hereby incorporated by reference in its entirety.

FIG. 3 shows an example diagram 300 of a content evaluation module 108, in accordance with some embodiments. The content evaluation module 108 includes an evaluation content datastore 302, processing modules 304, and a predicted tag analysis module 312. One or more of the modules of the content evaluation module 108 may be coupled to one another or to modules not explicitly shown in FIG. 3.

The evaluation content datastore 302 may comprise a datastore configured to store content that is to be evaluated. In some embodiments, the evaluation content datastore 302 includes at least a portion of the images, memes, videos, interactive audiovisual material, and other content items that are uploaded and/or being uploaded by users of a social networking system to the social networking system. For example, the evaluation content datastore 302 may include items that users of a social networking system are uploading but have not yet tagged.

The processing modules 304 may process evaluation content items from evaluation content datastore 302 and user metadata associated with these content items. The processing modules 304 include a content processing module 306, a user metadata processing module 308, and a combined representation module 310.

The content processing module 306 may process content from the evaluation content datastore 302. In an embodiment, the content processing module 306 represents evaluation content items as content item vectors. The content processing module 306 may also use a content transformation matrix to transform the content item vectors into a format that can be combined with a representation of user metadata. The content transformation matrix may have been trained by the embedding space training module 106 during the training phase as discussed further herein. The content processing module 306 may use machine recognition techniques, neural networks, such as convolutional neural networks, etc. The content processing module 306 may provide representations of content items to the other modules of the content evaluation module 108.

The user metadata processing module 308 may process user metadata associated with the content from the evaluation content datastore. In various embodiments, the user metadata processing module 308 represents user metadata associated with evaluation content items as user metadata vectors. The user metadata processing module 308 may also implement a user metadata transformation matrix to transform user metadata vectors into a format that can be combined with representations of content items. The user metadata transformation matrix may have been trained by the embedding space training module 106 during the training phase as discussed further herein. The user metadata processing module 308 may provide representations of user metadata to the other modules of the content evaluation module 108.

The combined representation module 310 may combine the representations of the specific content items and the representations of the user metadata with one another to obtain a combined representation that can be embedded in the common embedding space. The combined representation module 310 may represent combinations of content and user metadata in a format similar to the format used by the combined representation module 212, shown in FIG. 2. The combined representation module 310 may provide a combined representation that represents combinations of content and user metadata in a format that can be stored in the common embedding space. In an embodiment, the combined representation module 310 may have been trained to combine the output of the content transformation matrix and the output of the user metadata transformation matrix during the training phase.

The predicted tag analysis module 312 may predict tags for combinations of content items and user metadata in the evaluation content datastore 302 based on tags used for similar combinations of content items and user metadata generated during the training phase. In an embodiment, the predicted tag analysis module 312 identifies tags within a threshold distance of a combined representation of an evaluation content item and user metadata for that evaluation content item at a point in the common embedding space. The determination of a threshold distance of the projected point may be configurable, and in various embodiments, a nearest neighbors algorithm may be used. In some embodiments, the predicted tag analysis module 312 identifies a specified number of tags (e.g., the ten closest tags to the point in the common embedding space). In various embodiments, the predicted tag analysis module 312 provides a distance from the point associated with a combined representation of an evaluation content item and user metadata for an evaluation content item, and retrieves all tags within that distance of the point. The predicted tag analysis module 312 may provide the retrieved tags as predicted tags that the user is likely to use with respect to the specific combinations of content items and user metadata in the evaluation content datastore 302.

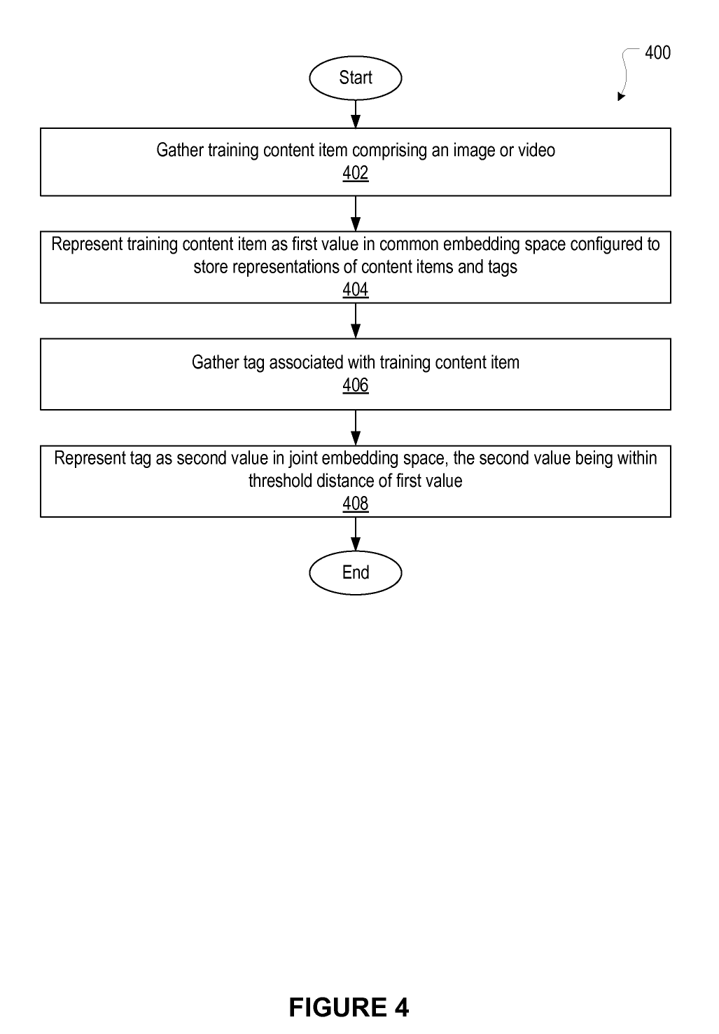

FIG. 4 shows an example diagram 400 of a process for training to embed content items and tags, in accordance with some embodiments. The diagram 400 relates to a training process for embedding representations of content items and tags in the common embedding space without use of user metadata. The diagram 400 is discussed in conjunction with the embedding space training module 106 and the common embedding space, discussed further herein.

At step 402, a training content item comprising an image or video is gathered. In some embodiments, the content processing module 208 gathers a training content item from the training content datastore 202. The training content item may be chosen to represent content that is uploaded to a system, such as a social networking system. The content processing module 208 may provide the training content item to the combined representation module 212.

At step 404, the training content item is represented as a first value in a common embedding space that is configured to store representations of content items and tags. The combined representation module 212 may represent the training content item as a first value in the common embedding space. The training content item may be represented based on a content transformation matrix.

At step 406, a tag associated with the training content item is gathered. In various embodiments, the training tag processing module 214 gathers a tag associated with the training content item. More specifically, the training tag processing module 214 may gather specific hashtags that may be associated with the training content item in the training content datastore 202.

At step 408, the tag is represented as a second value in the common embedding space, where the second value is within the threshold distance of the first value. The training tag embedding module 216 may represent the training tag as a second value. The tag may be represented based on a tag transformation matrix. The second value may be such that its location in the common embedding space is within a threshold distance of or close to the first value. The content transformation matrix and the tag transformation matrix can be trained to embed associated content items and tags within the threshold distance from one another.

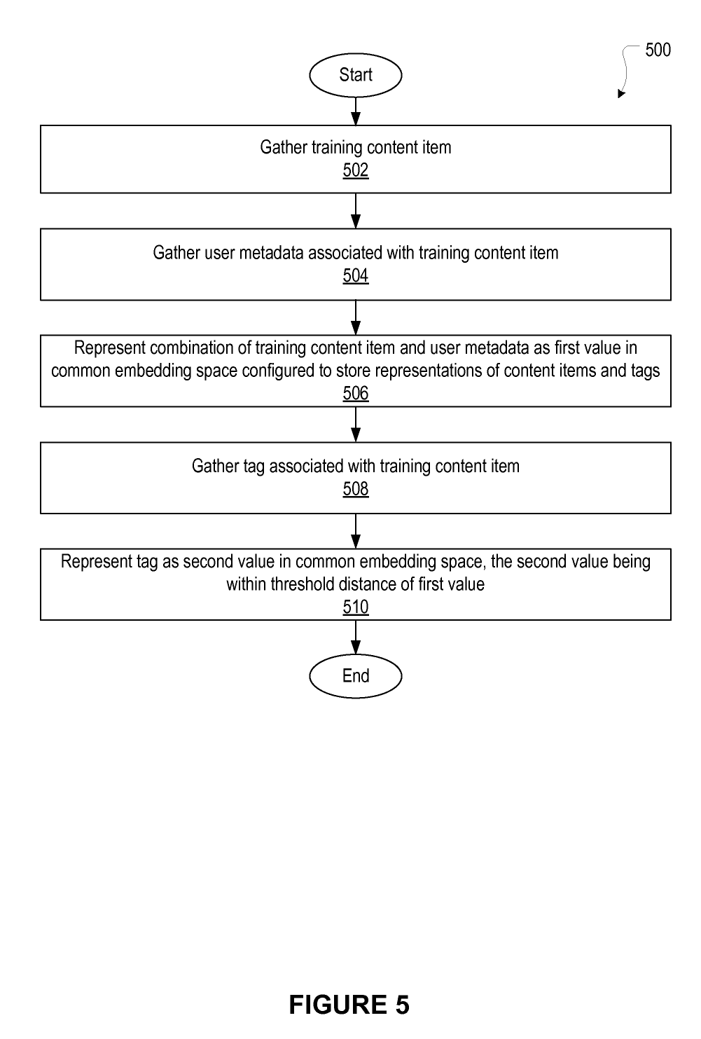

FIG. 5 shows an example diagram 500 of a process for training to embed content items and tags, in accordance with some embodiments. The diagram 500 relates to use of user metadata in a training process for embedding representations of content items and tags in the common embedding space. The diagram 500 is discussed in conjunction with the embedding space training module 106 and the joint common embedding space, as discussed further herein.

At step 502, a training content item is gathered. In some embodiments, the content processing module 208 gathers a training content item from the training content datastore 202. The training content item may be represented based on a content transformation matrix. The training content item may be chosen to represent content that is uploaded to a system, such as a social networking system. The content processing module 208 may provide the training content item to the combined representation module 212.

At step 504, user metadata associated with the training content item is gathered. In various embodiments, the user metadata processing module 210 gathers user metadata associated with the training content item from the training content datastore 202. The user metadata may be represented based on a user metadata transformation matrix. The user metadata may comprise information related to a user who generated, uploaded, etc. the training content item. The user metadata processing module 210 may provide the user metadata to the combined representation module 212.

At step 506, a combination of the representations of the training content item and the user metadata may be represented as a first value in the common embedding space that is configured to store representations of content items and tags. The combined representation module 212 may represent a combination of the representations of the training content item and the user metadata as a first value in the common embedding space.

At step 508, a tag associated with the training content item is gathered. In various embodiments, the training tag processing module 214 gathers a tag associated with the training content item. More specifically, the training tag processing module 214 may gather specific hashtags that may be associated with the training content item in the training content datastore 202.

At step 510, the tag is represented as a second value in the common embedding space, where the second value is within a threshold distance of the first value. The tag may be represented based on a tag transformation matrix. The training tag embedding module 216 may represent the training tag as a second value. The second value may be such that its location in the common embedding space is within a threshold distance from the first value. The content transformation matrix, the user metadata transformation matrix, and the tag transformation matrix can be trained to embed related content items and tags within a threshold distance from one another.

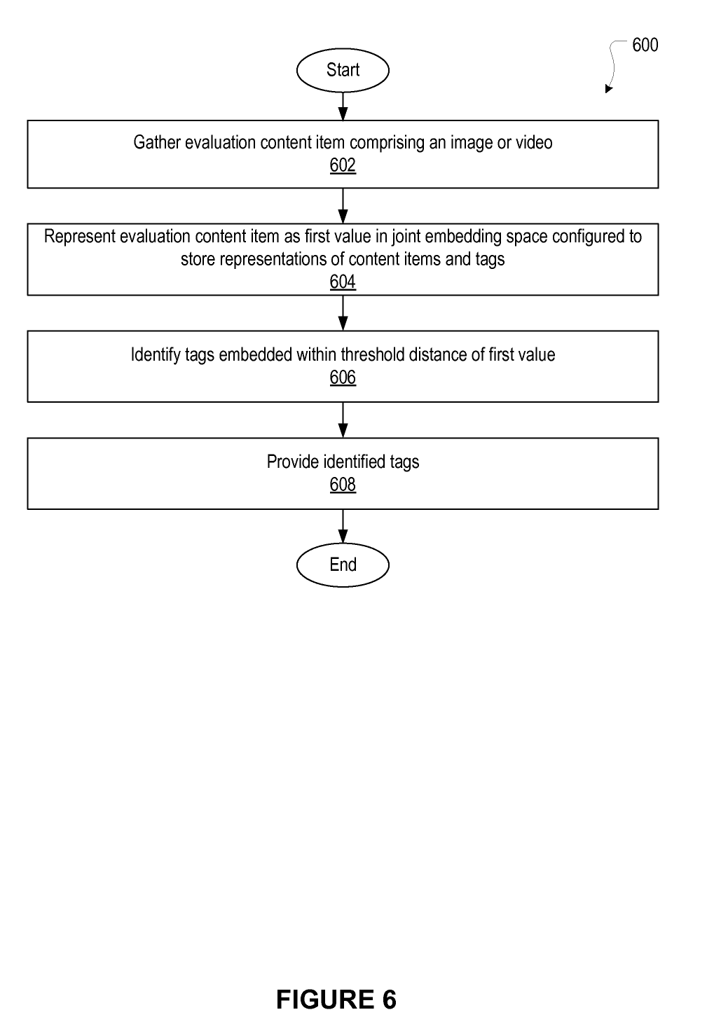

FIG. 6 shows an example diagram 600 of a process for predicting tags for a content item, in accordance with some embodiments. The diagram 600 relates to an evaluation process for predicting tags without use of user metadata. The diagram 600 is discussed in conjunction with the content evaluation module 108 and the common embedding space, as discussed further herein.

At step 602, an evaluation content item comprising an image or video is gathered. The content processing module 306 may gather an evaluation content item comprising an image or video. The evaluation content item may be represented based on a content transformation matrix that was trained during the training phase. At step 604, the evaluation content item is represented as a first value in a common embedding space that is configured to store representations of content items and tags. The combined representation module 310 may represent the evaluation content item as a first value in the common embedding space.

At step 606, embedded tags within a threshold distance of the first value are identified. In an embodiment, the predicted tag analysis module 312 identifies tags within the threshold distance of the first value. At step 608, the identified tags are provided. The predicted tag analysis module 312 may provide the identified tags.

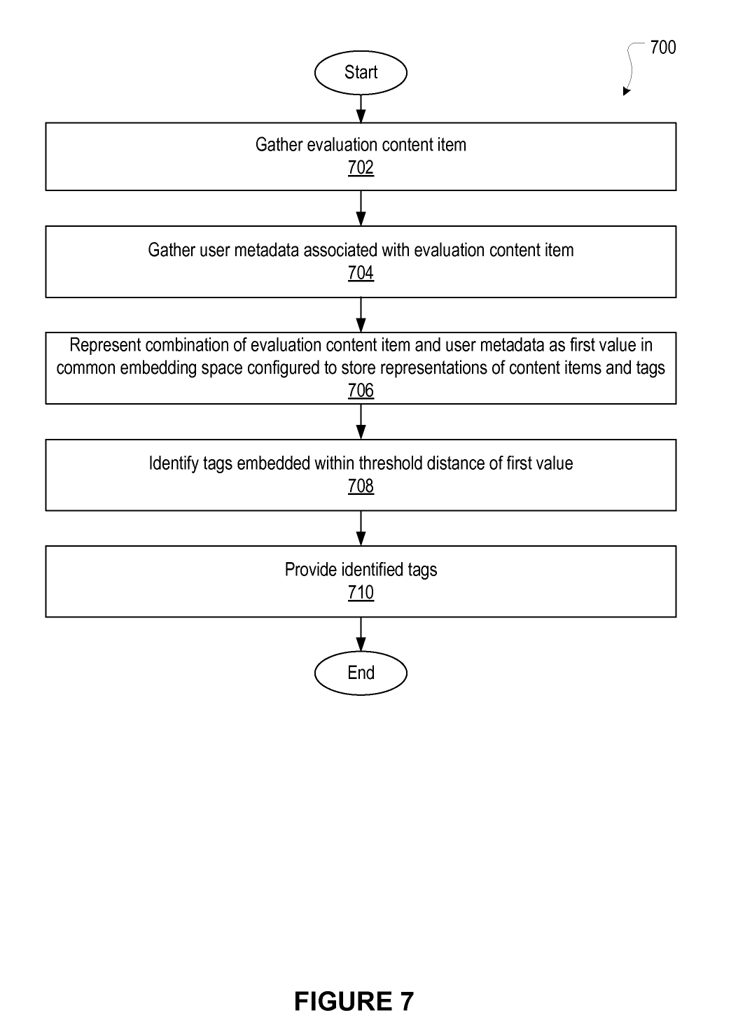

FIG. 7 shows an example diagram 700 of a process for predicting tags for a content item, in accordance with some embodiments. The diagram 700 relates to use of user metadata in an evaluation process for predicting tags. The diagram 700 is discussed in conjunction with the content evaluation module 108 and the common embedding space, as discussed further herein.

At step 702, an evaluation content item is gathered. The content processing module 306 may gather an evaluation content item. The evaluation content item may be represented based on a content transformation matrix that was trained during a training phase. At step 704, user metadata associated with the evaluation content item is gathered. The user metadata processing module 308 may gather user metadata associated with the evaluation content item. The user metadata may be represented based on a user metadata transformation matrix that was trained during a training phase. At step 706, a combination of the evaluation content item and the user metadata is represented as a first value in a common embedding space that is configured to store representations of content items and tags. The combination processing module may represent the evaluation content item and the user metadata as a first value in the common embedding space.

At step 708, embedded tags within a threshold distance of the first value are identified. In an embodiment, the predicted tag analysis module 312 identifies tags within the threshold distance of the first value. At step 710, the identified tags are provided. The predicted tag analysis module 312 may provide the identified tags.

### Social Networking System—Example Implementation

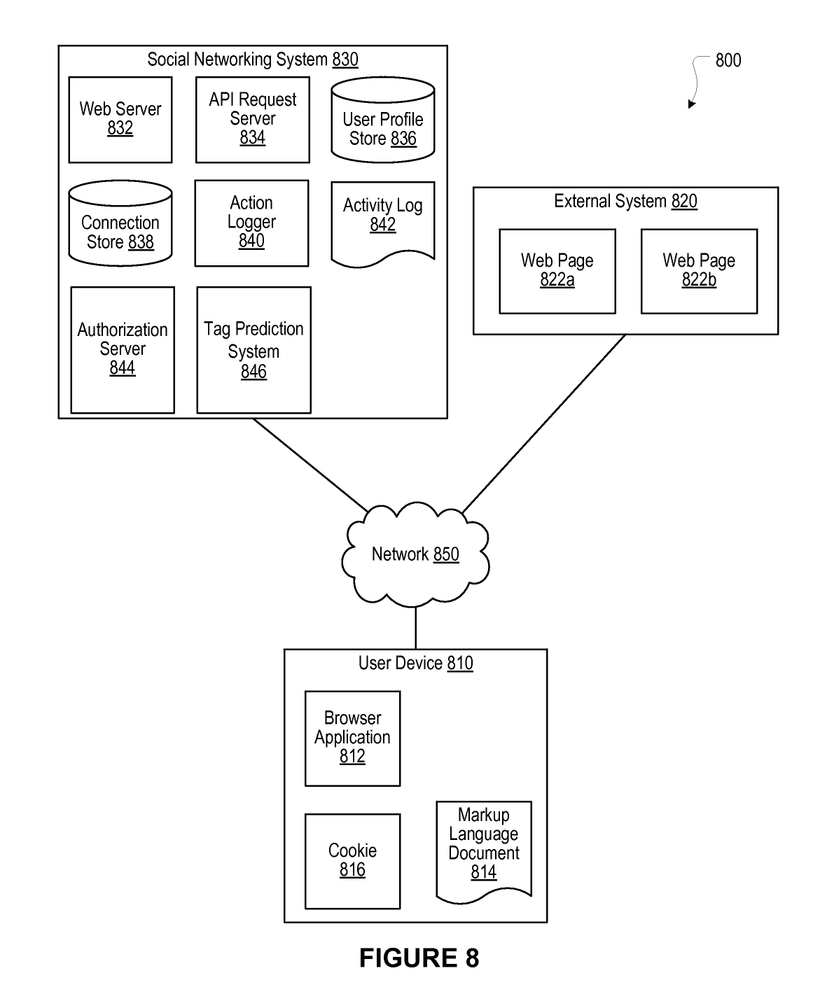

FIG. 8 is a network diagram of an example social networking environment 800 in which to implement the elements of the tag prediction system 102, in accordance with some embodiments. The social networking environment 800 includes one or more user devices 810, one or more external systems 820, a social networking system 830, and a network 850. In an embodiment, the social networking system discussed in connection with the embodiments described above may be implemented as the social networking system 830. For purposes of illustration, the embodiment of the social networking environment 800, shown by FIG. 8, includes a single external system 820 and a single user device 810. However, in other embodiments, the social networking environment 800 may include more user devices 810 and/or more external systems 820. In certain embodiments, the social networking system 830 is operated by a social networking system provider, whereas the external systems 820 are separate from the social networking system 830 in that they may be operated by different entities. In various embodiments, however, the social networking system 830 and the external systems 820 operate in conjunction to provide social networking services to users (or members) of the social networking system 830. In this sense, the social networking system 830 provides a platform or backbone, which other systems, such as external systems 820, may use to provide social networking services and functionalities to users across the Internet.

The user device 810 comprises one or more computing devices that can receive input from a user and transmit and receive data via the network 850. In one embodiment, the user device 810 is a conventional computer system executing, for example, a Microsoft Windows compatible operating system (OS), Apple OS X, and/or a Linux distribution. In another embodiment, the user device 810 can be a device having computer functionality, such as a smart-phone, a tablet, a personal digital assistant (PDA), a mobile telephone, etc. The user device 810 is configured to communicate via the network 850. The user device 810 can execute an application, for example, a browser application that allows a user of the user device 810 to interact with the social networking system 830. In another embodiment, the user device 810 interacts with the social networking system 830 through an application programming interface (API) provided by the native operating system of the user device 810, such as iOS and ANDROID. The user device 810 is configured to communicate with the external system 820 and the social networking system 830 via the network 850, which may comprise any combination of local area and/or wide area networks, using wired and/or wireless communication systems.

In one embodiment, the network 850 uses standard communications technologies and protocols. Thus, the network 850 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 850 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 850 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec). In various embodiments, the network 850 may be implemented as the network 850.

In one embodiment, the user device 810 may display content from the external system 820 and/or from the social networking system 830 by processing a markup language document 814 received from the external system 820 and from the social networking system 830 using a browser application 812. The markup language document 814 identifies content and one or more instructions describing formatting or presentation of the content. By executing the instructions included in the markup language document 814, the browser application 812 displays the identified content using the format or presentation described by the markup language document 814. For example, the markup language document 814 includes instructions for generating and displaying a web page having multiple frames that include text and/or image data retrieved from the external system 820 and the social networking system 830. In various embodiments, the markup language document 814 comprises a data file including extensible markup language (XML) data, extensible hypertext markup language (XHTML) data, or other markup language data. Additionally, the markup language document 814 may include JavaScript Object Notation (JSON) data, JSON with padding (JSONP), and JavaScript data to facilitate data-interchange between the external system 820 and the user device 810. The browser application 812 on the user device 810 may use a JavaScript compiler to decode the markup language document 814. In an embodiment, the user device 810 may include a client application module 818. The client application module 818 may be implemented as the client application module 114.

The markup language document 814 may also include, or link to, applications or application frameworks such as FLASH™ or Unity™ applications, the SilverLight™ application framework, etc.

In one embodiment, the user device 810 also includes one or more cookies 816 including data indicating whether a user of the user device 810 is logged into the social networking system 830, which may enable modification of the data communicated from the social networking system 830 to the user device 810.

The external system 820 includes one or more web servers that include one or more web pages 822a, 822b, which are communicated to the user device 810 using the network 850. The external system 820 is separate from the social networking system 830. For example, the external system 820 is associated with a first domain, while the social networking system 830 is associated with a separate social networking domain. Web pages 822a, 822b, included in the external system 820, comprise markup language documents 814 identifying content and including instructions specifying formatting or presentation of the identified content. The external system may also include content module(s) 824, as described in more detail herein. In various embodiments, the content module(s) 824 may be implemented as the content module(s) 82.

The social networking system 830 includes one or more computing devices for a social networking system, including a plurality of users, and providing users of the social networking system with the ability to communicate and interact with other users of the social networking system. In some instances, the social networking system can be represented by a graph, i.e., a data structure including edges and nodes. Other data structures can also be used to represent the social networking system, including but not limited to databases, objects, classes, Meta elements, files, or any other data structure. The social networking system 830 may be administered, managed, or controlled by an operator. The operator of the social networking system 830 may be a human being, an automated application, or a series of applications for managing content, regulating policies, and collecting usage metrics within the social networking system 830. Any type of operator may be used.

Users may join the social networking system 830 and then add connections to any number of other users of the social networking system 830 to whom they desire to be connected. As used herein, the term “friend” refers to any other user of the social networking system 830 to whom a user has formed a connection, association, or relationship via the social networking system 830. For example, in an embodiment, if users in the social networking system 830 are represented as nodes in the social graph, the term “friend” can refer to an edge formed between and directly connecting two user nodes.

Connections may be added explicitly by a user or may be automatically created by the social networking system 830 based on common characteristics of the users (e.g., users who are alumni of the same educational institution). For example, a first user specifically selects a particular other user to be a friend. Connections in the social networking system 830 are usually in both directions, but need not be, so the terms “user” and “friend” depend on the frame of reference. Connections between users of the social networking system 830 are usually bilateral (“two-way”), or “mutual,” but connections may also be unilateral, or “one-way.” For example, if Bob and Joe are both users of the social networking system 830 and connected to each other, Bob and Joe are each other's connections. If, on the other hand, Bob wishes to connect to Joe to view data communicated to the social networking system 830 by Joe, but Joe does not wish to form a mutual connection, a unilateral connection may be established. The connection between users may be a direct connection; however, some embodiments of the social networking system 830 allow the connection to be indirect via one or more levels of connections or degrees of separation.

In addition to establishing and maintaining connections between users and allowing interactions between users, the social networking system 830 provides users with the ability to take actions on various types of items supported by the social networking system 830. These items may include groups or networks (i.e., social networks of people, entities, and concepts) to which users of the social networking system 830 may belong, events or calendar entries in which a user might be interested, computer-based applications that a user may use via the social networking system 830, transactions that allow users to buy or sell items via services provided by or through the social networking system 830, and interactions with advertisements that a user may perform on or off the social networking system 830. These are just a few examples of the items upon which a user may act on the social networking system 830, and many others are possible. A user may interact with anything that is capable of being represented in the social networking system 830 or in the external system 820, separate from the social networking system 830, or coupled to the social networking system 830 via the network 850.

The social networking system 830 is also capable of linking a variety of entities. For example, the social networking system 830 enables users to interact with each other as well as external systems 820 or other entities through an API, a web service, or other communication channels. The social networking system 830 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 830. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 830 modifies edges connecting the various nodes to reflect the relationships and interactions.

The social networking system 830 also includes user-generated content, which enhances a user's interactions with the social networking system 830. User-generated content may include anything a user can add, upload, send, or “post” to the social networking system 830. For example, a user communicates posts to the social networking system 830 from a user device 810. Posts may include data such as status updates or other textual data, location information, images such as photos, videos, links, music or other similar data and/or media. Content may also be added to the social networking system 830 by a third party. Content “items” are represented as objects in the social networking system 830. In this way, users of the social networking system 830 are encouraged to communicate with each other by posting text and content items of various types of media through various communication channels. Such communication increases the interaction of users with each other and increases the frequency with which users interact with the social networking system 830.

The social networking system 830 includes a web server 832, an API request server 834, a user profile store 836, a connection store 838, an action logger 840, an activity log 842, an authorization server 844, a tag prediction system 846, and content system(s) 848. In an embodiment, the social networking system 830 may include additional, fewer, or different components for various applications. Other components, such as network interfaces, security mechanisms, load balancers, failover servers, management and network operations consoles, and the like are not shown so as to not obscure the details of the system.

The user profile store 836 maintains information about user accounts, including biographic, demographic, and other types of descriptive information, such as work experience, educational history, hobbies or preferences, location, and the like that has been declared by users or inferred by the social networking system 830. This information is stored in the user profile store 836 such that each user is uniquely identified. The social networking system 830 also stores data describing one or more connections between different users in the connection store 838. The connection information may indicate users who have similar or common work experience, group memberships, hobbies, or educational history. Additionally, the social networking system 830 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 830, such as non-person entities, buckets, cluster centers, images, interests, pages, external systems, concepts, and the like are also stored in the connection store 838.

The social networking system 830 maintains data about objects with which a user may interact. To maintain this data, the user profile store 836 and the connection store 838 store instances of the corresponding type of objects maintained by the social networking system 830. Each object type has information fields that are suitable for storing information appropriate to the type of object. For example, the user profile store 836 contains data structures with fields suitable for describing a user's account and information related to a user's account. When a new object of a particular type is created, the social networking system 830 initializes a new data structure of the corresponding type, assigns a unique object identifier to it, and begins to add data to the object as needed. This might occur, for example, when a user becomes a user of the social networking system 830, the social networking system 830 generates a new instance of a user profile in the user profile store 836, assigns a unique identifier to the user account, and begins to populate the fields of the user account with information provided by the user.

The connection store 838 includes data structures suitable for describing a user's connections to other users, connections to external systems 820 or connections to other entities. The connection store 838 may also associate a connection type with a user's connections, which may be used in conjunction with the user's privacy setting to regulate access to information about the user. In an embodiment, the user profile store 836 and the connection store 838 may be implemented as a federated database.

Data stored in the connection store 838, the user profile store 836, and the activity log 842 enables the social networking system 830 to generate the social graph that uses nodes to identify various objects and edges connecting nodes to identify relationships between different objects. For example, if a first user establishes a connection with a second user in the social networking system 830, user accounts of the first user and the second user from the user profile store 836 may act as nodes in the social graph. The connection between the first user and the second user stored by the connection store 838 is an edge between the nodes associated with the first user and the second user. Continuing this example, the second user may then send the first user a message within the social networking system 830. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 830 (or, alternatively, in an image maintained by another system outside of the social networking system 830). The image may itself be represented as a node in the social networking system 830. This tagging action may create edges between the first user and the second user as well as create an edge between each of the users and the image, which is also a node in the social graph. In yet another example, if a user confirms attending an event, the user and the event are nodes obtained from the user profile store 836, where the attendance of the event is an edge between the nodes that may be retrieved from the activity log 842. By generating and maintaining the social graph, the social networking system 830 includes data describing many different types of objects and the interactions and connections among those objects, providing a rich source of socially relevant information.

The web server 832 links the social networking system 830 to one or more user devices 810 and/or one or more external systems 820 via the network 850. The web server 832 serves web pages, as well as other web-related content, such as Java, JavaScript, Flash, XML, and so forth. The web server 832 may include a mail server or other messaging functionality for receiving and routing messages between the social networking system 830 and one or more user devices 810. The messages can be instant messages, queued messages (e.g., email), text and SMS messages, or any other suitable messaging format.

The API request server 834 allows one or more external systems 820 and user devices 810 to call access information from the social networking system 830 by calling one or more API functions. The API request server 834 may also allow external systems 820 to send information to the social networking system 830 by calling APIs. The external system 820, in one embodiment, sends an API request to the social networking system 830 via the network 850, and the API request server 834 receives the API request. The API request server 834 processes the request by calling an API associated with the API request to generate an appropriate response, which the API request server 834 communicates to the external system 820 via the network 850. For example, responsive to an API request, the API request server 834 collects data associated with a user, such as the user's connections that have logged into the external system 820, and communicates the collected data to the external system 420. In another embodiment, the user device 810 communicates with the social networking system 830 via APIs in the same manner as external systems 820.

The action logger 840 is capable of receiving communications from the web server 832 about user actions on and/or off the social networking system 830. The action logger 840 populates the activity log 842 with information about user actions, enabling the social networking system 830 to discover various actions taken by its users within the social networking system 830 and outside of the social networking system 830. Any action that a particular user takes with respect to another node on the social networking system 830 may be associated with each user's account, through information maintained in the activity log 842 or in a similar database or other data repository. Examples of actions taken by a user within the social networking system 830 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 830, the action is recorded in the activity log 842. In one embodiment, the social networking system 830 maintains the activity log 842 as a database of entries. When an action is taken within the social networking system 830, an entry for the action is added to the activity log 842. The activity log 842 may be referred to as an action log.

Additionally, user actions may be associated with concepts and actions that occur within an entity outside of the social networking system 830, such as an external system 820 that is separate from the social networking system 830. For example, the action logger 840 may receive data describing a user's interaction with an external system 820 from the web server 832. In this example, the external system 820 reports a user's interaction according to structured actions and objects in the social graph.

Other examples of actions where a user interacts with an external system 820 include a user expressing an interest in an external system 820 or another entity, a user posting a comment to the social networking system 830 that discusses an external system 820 or a web page 822a within the external system 820, a user posting to the social networking system 830 a Uniform Resource Locator (URL) or other identifier associated with an external system 820, a user attending an event associated with an external system 820, or any other action by a user that is related to an external system 820. Thus, the activity log 842 may include actions describing interactions between a user of the social networking system 830 and an external system 820 that is separate from the social networking system 830.

The authorization server 844 enforces one or more privacy settings of the users of the social networking system 830. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 820, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 820. One embodiment allows the specification of the set of entities to comprise an enumeration of entities. For example, the user may provide a list of external systems 820 that are allowed to access certain information. Another embodiment allows the specification to comprise a set of entities along with exceptions that are not allowed to access the information. For example, a user may allow all external systems 820 to access the user's work information, but specify a list of external systems 820 that are not allowed to access the work information. Certain embodiments call the list of exceptions that are not allowed to access certain information a “block list”. External systems 820 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 844 contains logic to determine if certain information associated with a user can be accessed by a user's friends, external systems 820, and/or other applications and entities. The external system 820 may need authorization from the authorization server 844 to access the user's more private and sensitive information, such as the user's work phone number. Based on the user's privacy settings, the authorization server 844 determines if another user, the external system 820, an application, or another entity is allowed to access information associated with the user, including information about actions taken by the user.

The social networking system 830 may include the tag prediction system 846. In an embodiment, the tag prediction system 846 may be implemented as the tag prediction system 102, shown in FIG. 1 and discussed further herein.

### Hardware Implementation

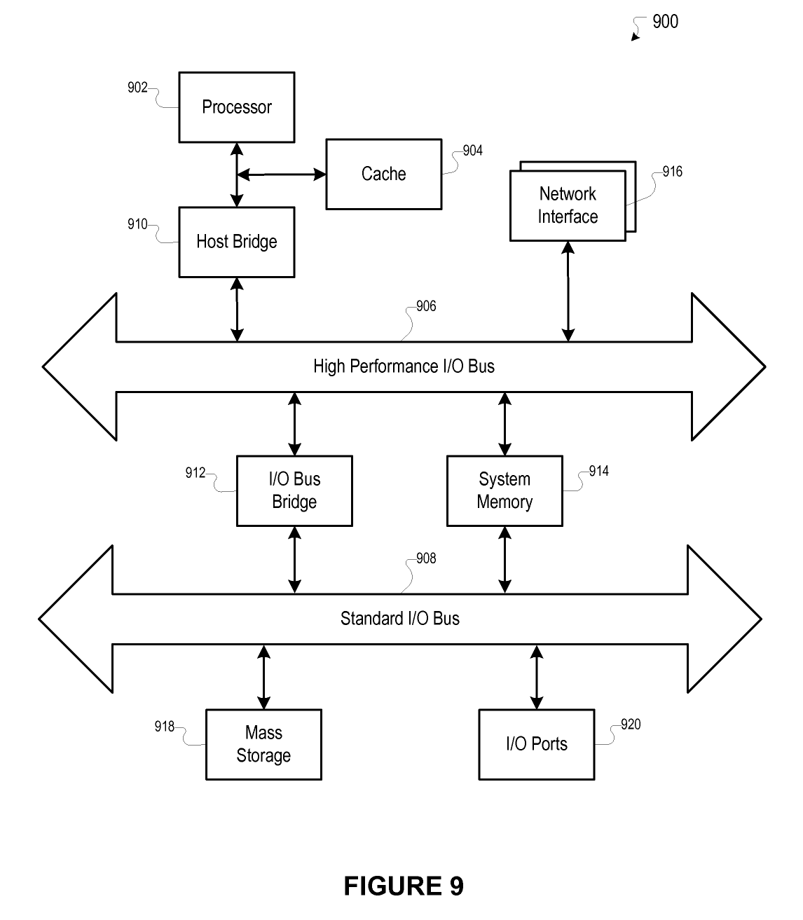

The foregoing processes and features can be implemented by a wide variety of machine and computer system architectures and in a wide variety of network and computing environments. FIG. 9 illustrates an example of a computer system 900 that may be used to implement one or more of the embodiments described herein in accordance with an embodiment. The computer system 900 includes sets of instructions for causing the computer system 900 to perform the processes and features discussed herein. The computer system 900 may be connected (e.g., networked) to other machines. In a networked deployment, the computer system 900 may operate in the capacity of a server machine or a client machine in a client-server network environment, or as a peer machine in a peer-to-peer (or distributed) network environment. In an embodiment, the computer system 900 may reside with the social networking system 830, the device 810, and the external system 820, or a component thereof. In an embodiment, the computer system 900 may be one server among many that constitutes all or part of the social networking system 830.

The computer system 900 includes a processor 902, a cache 904, and one or more executable modules and drivers, stored on a computer-readable medium, directed to the processes and features described herein. Additionally, the computer system 900 includes a high performance input/output (I/O) bus 906 and a standard I/O bus 908. A host bridge 910 couples processor 902 to high performance I/O bus 906, whereas I/O bus bridge 912 couples the two buses 906 and 908 to each other. A system memory 914 and a network interface 916 couple to high performance I/O bus 906. The computer system 900 may further include video memory and a display device coupled to the video memory (not shown). Mass storage 918 and I/O ports 920 couple to the standard I/O bus 908. The computer system 900 may optionally include a keyboard and pointing device, a display device, or other input/output devices (not shown) coupled to the standard I/O bus 908. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 900 are described in greater detail below. In particular, the network interface 916 provides communication between the computer system 900 and any of a wide range of networks, such as an Ethernet (e.g., IEEE 802.3) network, a backplane, etc. The mass storage 918 provides permanent storage for the data and programming instructions to perform the above-described processes and features implemented by the respective computing systems identified above, whereas the system memory 914 (e.g., DRAM) provides temporary storage for the data and programming instructions when executed by the processor 902. The I/O ports 920 may be one or more serial and/or parallel communication ports that provide communication between additional peripheral devices, which may be coupled to the computer system 900.

The computer system 900 may include a variety of system architectures, and various components of the computer system 900 may be rearranged. For example, the cache 904 may be on-chip with processor 902. Alternatively, the cache 904 and the processor 902 may be packed together as a “processor module”, with processor 902 being referred to as the “processor core”. Furthermore, certain embodiments may neither require nor include all of the above components. For example, peripheral devices coupled to the standard I/O bus 908 may couple to the high performance I/O bus 906. In addition, in some embodiments, only a single bus may exist, with the components of the computer system 900 being coupled to the single bus. Furthermore, the computer system 900 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 900 that, when read and executed by one or more processors, cause the computer system 900 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 900, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 902. Initially, the series of instructions may be stored on a storage device, such as the mass storage 918. However, the series of instructions can be stored on any suitable computer readable storage medium. Furthermore, the series of instructions need not be stored locally, and could be received from a remote storage device, such as a server on a network, via the network interface 916. The instructions are copied from the storage device, such as the mass storage 918, into the system memory 914 and then accessed and executed by the processor 902. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

What is claimed is:

1. A computer implemented method comprising:
in a training phase:
creating a first content item representation of a first content item based on a first content item transformation, the first content item comprising one or more of images and video;
creating a first tag representation of a first tag based on a first tag transformation, the first tag associated with the first content item; and
embedding the first content item representation and the first tag representation in an embedding space within a first threshold distance from one another.

2. The computer implemented method of claim 1, further comprising:
training the first content item transformation and the first tag transformation so that the first content item representation and the first tag representation in the embedding space are embedded within the first threshold distance from one another.

3. The computer implemented method of claim 1, further comprising:
in an evaluation stage:
creating a second content item representation of a second content item based on a second content item transformation, the second content item comprising one or more of images and video;
embedding the second content item representation in the embedding space; and
identifying at least one tag associated with the second content item in the embedding space within a second threshold distance from the second content item representation.

4. The computer implemented method of claim 1, wherein the first content item transformation or the first tag transformation is implemented using a matrix.

5. The computer implemented method of claim 1, wherein the first content item transformation or the first tag transformation comprises a linear transformation.

6. The computer implemented method of claim 1, wherein the first content item transformation or the first tag transformation comprises a nonlinear transformation.

7. The computer implemented method of claim 1, wherein creating the first content item representation of the first content item based on the first content item transformation comprises:
creating a content item vector corresponding to the content item;
multiplying the content item vector by a content transformation matrix.

8. The computer implemented method of claim 1, wherein creating the first tag representation of the first tag based on the first tag transformation comprises:
creating a first tag vector corresponding to the first tag;
multiplying the first tag vector by a first tag transformation matrix.

9. The computer implemented method of claim 1, wherein the first tag comprises a hashtag associated with the first content item.

10. The computer implemented method of claim 1, wherein the first content item comprises an image or video being uploaded to a social networking system.

11. A system comprising:
at least one processor;
a memory storing instructions configured to instruct the at least one processor to perform:
in a training phase:
creating a first content item representation of a first content item based on a first content item transformation, the first content item comprising one or more of images and video;
creating a first tag representation of a first tag based on a first tag transformation, the first tag associated with the first content item; and
embedding the first content item representation and the first tag representation in an embedding space within a first threshold distance from one another.

12. The system of claim 11, wherein the instructions are configured to instruct the at least one processor to perform:
training the first content item transformation and the first tag transformation so that the first content item representation and the first tag representation in the embedding space are embedded within the first threshold distance from one another.

13. The system of claim 11, wherein the instructions are configured to instruct the at least one processor to perform:
in an evaluation stage:
creating a second content item representation of a second content item based on a second content item transformation, the second content item comprising one or more of images and video;
embedding the second content item representation in the embedding space; and
identifying at least one tag associated with the second content item in the embedding space within a second threshold distance from the second content item representation.

14. The system of claim 11, wherein the first content item transformation or the first tag transformation is implemented using a matrix.

15. The system of claim 11, wherein the first content item transformation or the first tag transformation comprises a linear transformation.

16. A computer storage medium storing computer-executable instructions that, when executed, cause a computer system to perform a computer-implemented method comprising:
in a training phase:
creating a first content item representation of a first content item based on a first content item transformation, the first content item comprising one or more of images and video;
creating a first tag representation of a first tag based on a first tag transformation, the first tag associated with the first content item;
embedding the first content item representation and the first tag representation in an embedding space within a first threshold distance from one another.

17. The computer storage medium of claim 16, wherein the computer-implemented method further comprises:
training the first content item transformation and the first tag transformation so that the first content item representation and the first tag representation in the embedding space are embedded within the first threshold distance from one another.

18. The computer storage medium of claim 16, wherein the computer-implemented method further comprises:
in an evaluation stage:
creating a second content item representation of a second content item based on a second content item transformation, the second content item comprising one or more of images and video;
embedding the second content item representation in the embedding space; and
identifying at least one tag associated with the second content item in the embedding space within a second threshold distance from the second content item representation.

19. The computer storage medium of claim 16, wherein the first content item transformation or the first tag transformation is implemented using a matrix.

20. The computer storage medium of claim 16, wherein the first content item transformation or the first tag transformation comprises a linear transformation.
